(19) United States
(12) Patent Application Publication
(10) Pub. No.: US 2026/0134096 A1
(43) Pub. Date: May 14, 2026

(54) SECURITY CONTROL ENGINE(S) FOR PREVENTING EXECUTION OF FILES BASED ON FILENAME PATTERNS AND FILE ACTIVITY HISTORY

(71) Applicant: Microsoft Technology Licensing, LLC, Redmond, WA (US)

(72) Inventors: Yaakov GARYANI, Raanana (IL); Roi TZADOK, Ramat Gan (IL)

(21) Appl. No.: 18/985,680

(22) Filed: Dec. 18, 2024

Related U.S. Application Data
(60) Provisional application No. 63/720,587, filed on Nov. 14, 2024.

(51) Int. Cl. G06F 21/55

(52) U.S. Cl. CPC G06F 21/554; G06F 2221/034

(57) ABSTRACT

Systems and methods herein provide a security control engine and its related functions. In an aspect, the security control engine detects an execution request to open a file from a client device and parses the file to determine a filename and/or a filename string. From the filename and/or filename string, the security control engine determines a filename pattern for the file. Based on the filename pattern, the security control engine determines whether the filename pattern contains a suspicious filename pattern. If the security control engine determines that the filename pattern contains a suspicious filename pattern, the security control engine determines a file activity history associated with the client device. Based on the file activity history of the client device and the filename pattern of the file, the security control engine then determines whether or not to block access to the file for the client device.

### CROSS REFERENCE TO RELATED APPLICATIONS

This application claims the benefit of and priority to Provisional Patent Application entitled “SECURITY CONTROL ENGINE(S) FOR PREVENTING EXECUTION OF FILES BASED ON FILENAME PATTERNS AND FILE ACTIVITY HISTORY,” filed Nov. 14, 2024, under U.S. Provisional Application No. 63/720,587, the contents of which are incorporated herein by reference in their entirety for all purposes.

### TECHNICAL FIELD

Aspects of the disclosure are related to the field of computer software applications and services and, in particular, to security control engines for detecting files containing filename patterns associated with malicious activity and preventing execution of such detected files.

### BACKGROUND

In today's digital landscape, cyber-attacks increasingly exploit social engineering techniques to infiltrate organizations, often as a means of initial access. Unlike traditional attacks that rely on software vulnerabilities, social engineering targets human error, manipulating individuals into unintentionally compromising security, such as by executing a file containing malicious content. This presents a unique challenge for cybersecurity, as standard antivirus solutions are often ineffective against attacks rooted in human behavior. To counter this, companies emphasize the importance of awareness training for employees, aiming to equip them with the knowledge to recognize and resist social engineering tactics. However, even with comprehensive training programs, attackers continue to exploit human vulnerabilities to gain initial access needed to launch malicious activities such as security breaches and data theft.

### SUMMARY

Technology disclosed herein includes software applications and services that provide a security control engine, and its related functions. In an aspect, the security control engine detects a request to open a file from a client device. Responsive to detecting the request, the security control engine parses the file to determine one or more of the filename or the filename string associated with the file. Based on the filename and/or the filename string, the security control engine determines whether or not the file contains a suspicious filename pattern. As described in greater detail below, this process involves determining, by the security control engine, a filename pattern for the file based on the filename and/or filename string and comparing the filename pattern to a listing of known suspicious filename patterns.

If the file is determined to contain a suspicious filename pattern, thus indicating potentially malicious activity, the security control engine then determines file interaction characteristics of the requesting client device. For example, the security control engine determines a file activity history for the client device that identifies what files and types, including filename patterns, the client device commonly interacts with. In some cases, the security control engine also analyzes what programs are installed and frequently interacted with to determine whether the suspicious filename pattern deviates from the client's typical behavior. The client device's file interaction characteristics may, in some embodiments, be analyzed alongside other relevant information about the client device, such as a job position of a respective user, an associated department, or the other client devices that frequently interact with the requesting client device.

Based on the file interaction characteristics, the security control engine determines whether or not to grant the request to access the file. In some cases, the security control engine modifies an execution policy based on the specific file interaction characteristics of the client device. For instance, the execution policy may indicate that all files containing the suspicious filename pattern should be blocked from execution. However, based on the file characteristics of the client device, the security control engine determines that the client device commonly interacts with files having the same or similar filename patterns. As such, the security control engine modifies the execution policy for the client device to allow the client device to access the file. Conversely, if the security control engine determines, based on the file characteristics of the client device that the client device does not routinely interact with files containing similar filename patterns, then the security control engine may block execution of the file.

This Summary is provided to introduce a selection of concepts in a simplified form that are further described below in the Technical Disclosure. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a security control engine, according to an embodiment herein;

FIG. 2 illustrates an example operational system in which a security control engine is provided, according to an embodiment provided herein;

FIG. 3 illustrates a process for providing a security control engine and its related functions, according to an embodiment herein; and

FIG. 4 shows an example client device suitable for providing a security control engine and related functions, according to an embodiment herein.

### DETAILED DESCRIPTION

In recent years, cyber-attacks have evolved significantly, with an increasing reliance on social engineering to bypass traditional security measures. Rather than exploiting software vulnerabilities, attackers now focus on manipulating human behavior, using tactics such as phishing, baiting, and pretexting to deceive individuals into revealing sensitive information or granting unauthorized access. This shift places people, rather than systems, at the center of cybersecurity defenses, making it harder for conventional antivirus solutions to detect and mitigate threats. As these attacks grow more sophisticated and personalized, organizations face the urgent challenge of protecting themselves against an adversary that can adapt quickly, exploiting human trust and error to infiltrate even the most secure networks.

A common tactic in social engineering-based cyber-attacks involves the use of deceptive, malicious filenames designed to entice individuals into executing dangerous files. Attackers craft filenames that appear trustworthy or intriguing, such as “Invoice_2024.pdf,” “Employee_Benefits_Details.xlsx,” or “Urgent_Project_Proposal.docx,” preying on a recipient's curiosity or sense of urgency. These files often masquerade as routine documents, disguised as work-related attachments or personal interest items, to lower the target's guard. Once opened, however, the files execute malicious code, potentially installing malware, ransomware, or other harmful software that compromises the system. By mimicking familiar filenames and leveraging human trust, attackers can trick even cautious individuals into unknowingly exposing their systems, enabling cyber criminals to gain unauthorized access and inflict substantial damage.

In some cyber-attacks, attackers go a step further by modifying filename strings to disguise malicious files as safe, trusted documents. This can involve adding familiar terms, altering extensions, or using Unicode tricks like the Right-to-Left Override (RTLO) to mask the true nature of the file. For instance, an executable malware file might be named to appear as “Report.pdf” or “Image.jpg,” concealing its actual extension, such as “.exe” or “.scr,” that would normally raise suspicion. In cases of RTLO attacks, characters are reordered so that “malware [RTLO] fdp.exe” could appear to the user as “Malwareexc.pdf,” tricking users into thinking it's a harmless file type. By carefully manipulating filenames, attackers exploit a user's familiarity with typical document names and trusted file formats, increasing the chances of the file being opened without scrutiny. This technique is particularly effective in phishing emails or file-sharing platforms, where users often open attachments quickly, unaware that a simple filename tweak can hide a dangerous payload within.

To combat these types of social engineering cyber-attacks that exploit modified or misleading filenames, conventional security systems often implement strict security policies designed to limit the ability of client devices to execute or open potentially harmful files. For example, conventional security systems may enforce policies that prevent execution of all files containing certain filename patterns associated with known malicious activity or only allow files from trusted sources or with verified digital signatures to be executed. However, preventing the execution of all files containing specific filename patterns, such as known malicious filename patterns, in a one-size-fits-all manner can lead to unintended negative consequences, such as restricting productivity by impeding essential workflows or blocking legitimate files that are necessary for business operations. That is, conventional approaches to addressing socially engineered cyber-attacks often stifle process, disrupt essential workflows, and hinder the overall efficiency of an organization by over-blocking execution of files.

To address at least these shortcomings of conventional approaches, an example security control engine is provided herein for modifying execution policies for certain filename patterns in real-time to reflect a respective client device's file activity history. That is, the security control engine determines whether an execution policy configured to block execution of a file containing a filename pattern associated with known malicious activity should be adjusted for a particular client device based on the client device's past interactions with files. For example, if the client device historically interacts with legitimate files containing the same or similar filename patterns to the detected file, then the security control engine grants execution of the file, despite the file having a suspicious filename indicating possible malicious activity or the presence of an execution policy limiting the execution of files with the filename pattern.

Conversely, if the security control engine determines that a client device routinely opens files containing filename patterns indicating potential malicious activity and such files are historically subsequently identified to contain malicious content, then the security control engine may update or modify an execution policy for the client device limiting the device's ability to open files containing certain filename patterns. In still another example, the security control engine determines that one client device can execute a file, while another client device is blocked from executing the same file based on programs installed on each client device, as well as the file activity history for each device.

By tailoring execution policies based on the file interaction characteristics (e.g., file activity history, installed programs) of a client device and the filename pattern of the respective file, the security control engine offers several significant technical benefits over conventional security approaches. Unlike the one-size-fits-all policy methodologies of conventional security systems, the security control engine enables nuanced control over whether a specific client device can execute a given file. For example, the security control engine tightens execution policies for users who are more prone to be exploited by social engineering attempts, while loosening execution policies for users who are more adapt at identifying suspicious files. As such, the security control engine not only prevents over-blocking of file execution to include legitimate files, but the security control engine optimizes resource allocation by applying security measures proportionately, improving performance and user experience. Overall, by customizing execution policies on a per client device basis, the security control engine fosters granular control without impacting the productivity of the underlying business, thereby providing a more robust and responsive security framework.

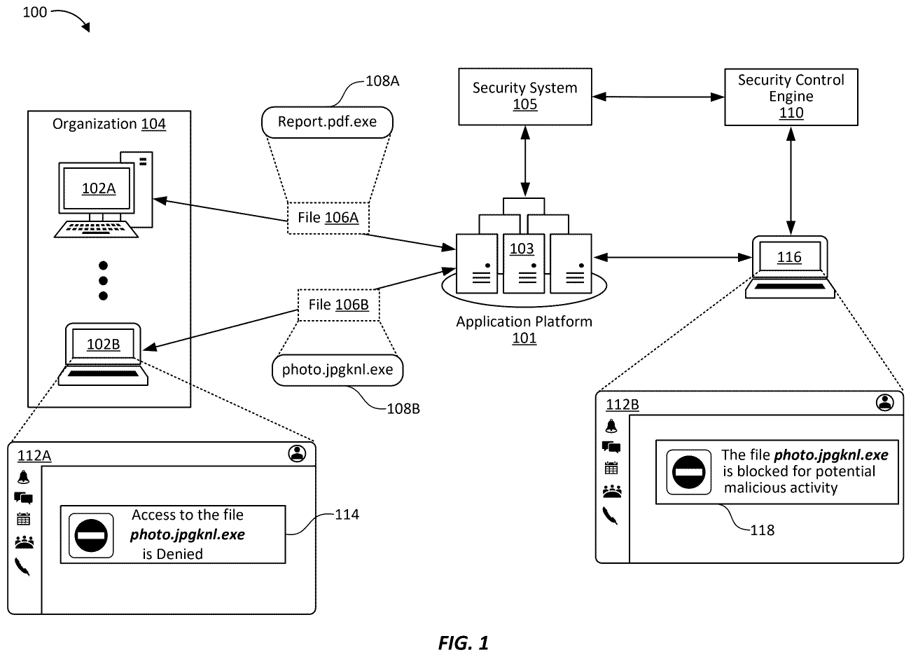

Turning now to FIG. 1, FIG. 1 illustrates an operational environment 100 for providing a security control engine 110, according to an embodiment herein. In particular, the operational environment 100 illustrates the environment 100 in which the security control engine 110 analyzes and modifies execution policies for files 106A and 106B as client devices 102A and 102B attempt to access them. As will be described in greater detail below, the security control engine 110 monitors and manages execution policies for the files 106A-B to prevent the client devices 102-B from inadvertently initiating malicious content. It should be appreciated that while the files 106A-B are illustrated and discussed in the singular, each client device 102A-B may request to execute or having multiple files 106A-B executing at a given time. Additionally, while the illustrated environment 100 includes the client devices 102A-B, any number of client devices may be included in the environment 100. As shown, the client devices 102A-B are part of an organization 104.

As illustrated, the client devices 102A-B access the files 106A-B through an application platform 101, which acts as an intermediary to facilitate seamless communication and data retrieval. The application platform 101 serves as a centralized platform that manages user authentication, permissions, and file distribution, ensuring that only authorized devices can access the requested files 106A-B. When the client devices 102A-B initiate a request for the files 106A-B, the platform 101 processes the request, verifies credentials, and provides secure access to the files 106A-B stored on backend systems. It should be appreciated that while FIG. 1 illustrates a distributed system through which the client devices 102A-B access the files 106A-B, in some embodiments, the files 106A-B may be stored and accessed locally on the client devices 102A-B, respectively.

Broadly speaking, the application platform 101 provides software application services to end points, such as the client devices 102A-B, examples of which include productivity applications and file management systems. The applications may be natively installed and executed applications, web-based applications that execute in the context of a local browser application, mobile applications, streaming applications, or any other suitable type of application. Example services and resources provided by the application platform 101 include front-end servers, application servers, content storage services, authorization and authentication services, and the like. These components collectively support seamless interactions between the client devices 102A-B and hosted services, ensuring robust performance and accessibility.

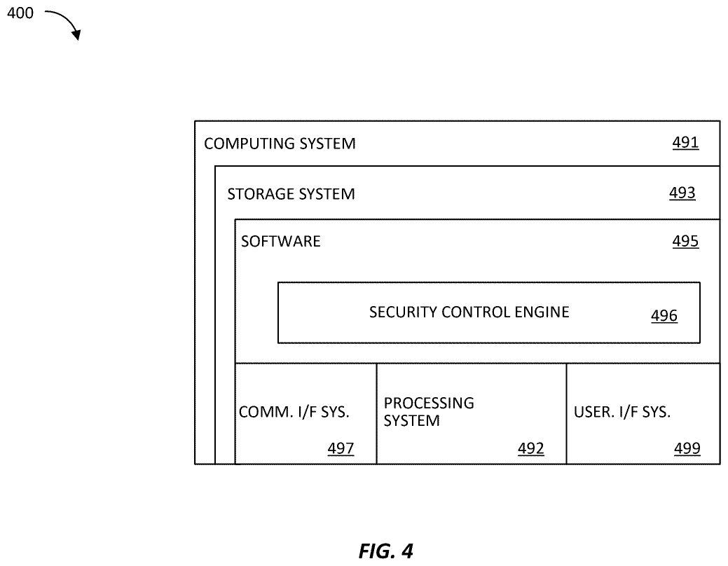

In the illustrated example, the application platform 101 operates in a cloud-based environment. As such, the application platform 101 employs one or more server computers 112 co-located with respect to each other or distributed across one or more data centers to deliver its functionalities and services. Example servers include web servers, application servers, virtual or physical servers, or any combination or variation thereof, of which computing apparatus 491 in FIG. 4 is broadly representative.

To interact with the application platform 101, the client devices 102A-B may communicate with the application platform 101 via one or more internets and intranets, the Internet, wired and wireless networks, local area networks (LANs), wide area networks (WANs), or any other type of network or combination thereof. Examples of the client devices 102A-B may include personal computers, tablet computers, mobile phones, gaming consoles, wearable devices, Internet of Things (IOT) devices, and any other suitable devices, of which computing apparatus 491 in FIG. 4 is also broadly representative.

As shown, the environment 100 also includes a security system 105 which may be integrated with the application platform 101 to maintain the integrity and security of the application platform 101 and interactions between the client devices 102A-B. In an example, the organization 104 may leverage the security system 105 to monitor, detect, and respond to potential threats that could compromise the platform 101 and/or the client devices 102A-B. To ensure the security of the organization 104 and/or the application platform 101, the security system 105 continuously analyzes network traffic, user behavior, and system activities to identify any anomalies or security risks. For example, the security system 105 may incorporate Microsoft Defender®, whose capabilities, including malware detection, advanced threat analytics, and incident response automation, help maintain the security and resilience of the application platform 101 against cyberattacks, protecting both client devices 102A-B and the data they access.

In the illustrated example, the client devices 102A-B represent users who are employed or associated with the organization 104. As such, the client devices 102A-B access, share, and manage files 106A-B as part of their job responsibilities in the daily operations of the organization 104. These files 106A-B may include documents, reports, project data, and other essential resources needed to perform various tasks. Users of the client devices 102A-B rely on streamlined access to these files 106A-B to collaborate effectively with colleagues, meet project deadlines, and maintain productivity throughout the organization 104. The accessibility of the files 106A-B ensures that employees can retrieve the information they need from anywhere within the organizational network, which includes the application platform 101, fostering efficiency and seamless workflows. Although the explanation herein focuses on the client devices 102A-B operating within the organization 104, the discussion is equally applicable to other scenarios, including embodiments in which the client devices 102A-B interact with the files 106A-B within a personal capacity.

The client devices 102A-B can access files 106A-B through various means, depending on the specific needs of the task and the organizational setup. In one example, such as the illustrated embodiment, one means of access is through the application platform 101, which acts as a secure and centralized hub for storing and managing files, including files 106A-B. As such, the client devices 102A-B may log into the application platform 101 to retrieve files 106A-B directly, ensuring controlled access through user authentication and data management protocols. Another common way the client devices 102A-B may access the files 106A-B is via email, either from other devices within the organization 104 or from external sources outside the organization 104. Additionally, in some embodiments, the application platform 101 may provide network drive or cloud-based storage capabilities, allowing client devices 102A-B to connect to a centralized storage system for easy access, real-time collaboration, and version control, enhancing both flexibility and security in file management.

To access the files 106A-B, the client devices 102A-B select the desired file and submit a request to execute it. This process could involve a simple double-click on the file 106A-B or right-clicking and selecting an “Open” or “Run” option from a contextual menu. Depending on the system configuration, users might also access the files 106A-B by using keyboard shortcuts or by navigating through an application interface provided by the application platform 101. Once the request is submitted, the application platform 101 processes the request, verifies access permissions, and executes the file 106A-B, ensuring secure and controlled file handling.

Each of the files 106A-B includes a respective filename, identified as filenames 108A-B. These filenames act as identifiers, providing users with essential details about the files, such as their intended content type, format, or purpose. For example, the filename 108A for the file 106A is “Report.pdf.exe” and the filename 108B for the file 106B is “photo.jpgknl.exe.” Each of these filenames 108A-B include filename patterns that indicate potential malicious activity. For example, the filename 108A may initially appear as a standard “Report.pdf” document to the client device 102A but actually has an executable extension that indicates it can run code. Similarly, the filename 108B may appear as an image file with a “jpg” format to the client device 102B but, in reality, includes an executable component. The “.exe” in each of these filenames may be concealed by file-naming tricks that hide the true extension, making the filenames 108A-B appear to be a different file type, such as a PDF or JPG, respectively. These filename patterns are designed to mislead users, prompting them to open what seems to be a harmless document or image while inadvertently executing malicious software.

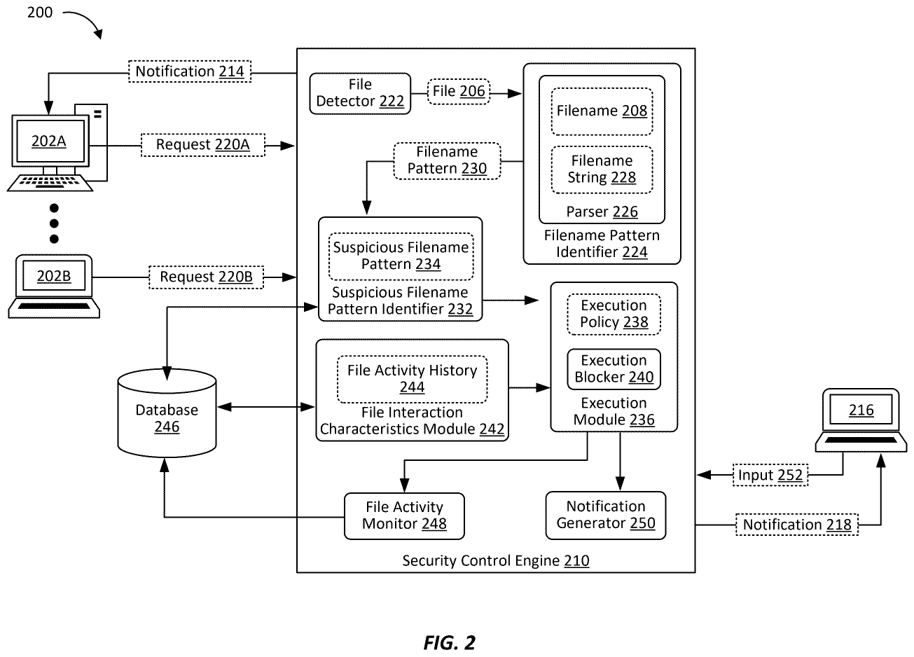

Because the filenames 108A-B contain .exe extensions, they may automatically execute when opened, initiating any embedded processes or commands within the files 106A-B. This executable nature means that, upon being accessed, the files 106A-B can run scripts, install software, or perform other programmed actions on the client devices 102A-B. This behavior is particularly significant as .exe files can pose a security risk if used maliciously. That is, the files 106A-B with extensions like “Report.pdf.exe” or “photo.jpgknl.exe” can be deceptive, appearing as harmless documents or images while containing malicious content. As such, filename patterns such as the filenames 108A-B that include an “.exe” extension are commonly employed in cyber-attacks, where attackers embed malicious code within seemingly innocuous filenames 108A-B to trick users into executing harmful software. Additional filename patterns that indicate potential malicious activity are described in greater detail below with respect to FIG. 2.

To combat socially engineered cyber-attacks, the security system 105 includes an integration with the security control engine 110. The security control engine 110 monitors for filename patterns that indicate potential malicious activity. For example, the security control engine 110 scrutinizes the filenames 108A-B of the files 106A-B for suspicious filename patterns, such as double extensions (e.g., “.pdf.exe” or “.jpgknl.exe,”) which are commonly used to mask executable content under the guise of legitimate file types. By employing advanced threat detection algorithms, the security control engine 110 can identify filename patterns that indicate potential malicious activity, herein also referred to as suspicious filename patterns, and flag or quarantine suspicious files before they are executed on the client devices 102A-B. As used herein, a suspicious file is a file, such as the files 106A-B having filenames 108A-B containing filename patterns (e.g., double extensions) indicating potential malicious activity. Once a suspicious file is detected, the security control engine 110 prevents the malicious activity by blocking execution of the files 106A-B, thereby protecting the application platform 101 and the organization 104 from potential breaches, data loss, and other security threats.

It should be appreciated that while the security control engine 110 is illustrated as integrated with the security system 105, in some embodiments, the security control engine 110 may be executed remotely by the application platform 101 or a third party, while in other embodiments the security control engine 110 may be installed and executed locally on the client devices 102A-B. In still other embodiments, one or more functions of the security control engine 110, as described herein, may be installed and executed locally on the client devices 102A-B, while the remaining functions are integrated and executed remotely via the application platform 101, the security system 105, or a third party.

As noted above, under conventional security techniques, once a suspicious filename pattern is detected, such as those found in filenames 108A-B, the files 106A-B are immediately blocked from executing. This preventive measure ensures that potentially harmful content is not activated, and the client devices 102A-B are unable to access the blocked files. However, these conventional security protocols do not take into account whether the client devices 102A-B have previously interacted with legitimate files bearing similar filename patterns or the specific roles of the client devices' 102A-B users within the organization 104. As a result, the files 106A-B are uniformly blocked based solely on the detection of the suspicious filename patterns, applying the same strict security measure across all users and devices 102A-B to prevent any potential security breaches.

However, in the normal course of business, such as part of their job roles, the client devices 102A-B may interact with the files 106A-B having suspicious filename patterns, such as those mimicking legitimate system files or using unconventional extensions (e.g., “invoice.exe” or “report.txt.vbs”). These filename patterns can be indicative of potentially harmful or misleading content designed to exploit user trust. However, blocking client devices 102A-B from accessing files 106A-B, based on such filename patterns alone, can have significant negative consequences. For instance, a file labeled “convert_png_to_jpg.exe” may be flagged as suspicious despite being essential for system maintenance, or a document named “project_summary.docx” with an uncommon naming convention might be erroneously restricted, disrupting the workflow of users relying on these files for critical tasks. Accordingly, conventional security approaches often lead to productivity slowdowns and impede essential operations within the organization 104, causing frustration and inefficiencies.

To manage suspicious files without interrupting workflows or reducing productivity within the organization 104, the security control engine 110 analyzes each suspicious file in view of the client device requesting access. For example, the security control engine 110 receives an indication that the client device 102B requests to access or execute the file 106B. Responsive to the indication, the security control engine 110 analyzes the filename 108B to determine that it includes a suspicious filename pattern, here a double extension. Since double extensions, specifically those includes an execution extension (.exe) are commonly employed by malicious actors, the security control engine 110 flags the file 106B as potentially containing malicious content. However, instead of blanket blocking the client device's 102B access to the file 106B, the security control engine 110 analyzes the execution policy in view of the client device 102B to determine whether or not to allow access to the file 106B.

To analyze whether the execution policy should be adjusted to allow the client device 102B to access the file 106B, the security control engine 110 determines the file interaction characteristics of the client device 102B. In particular, the security control engine 110 determines the file interaction characteristics of the client device 102B by actively analyzing its file activity history and associated programs. By examining legitimate files and respective types that the client device 102B frequently interacts with, the security control engine 110 can identify commonly interacted with filename patterns. In some embodiments, the security control engine tracks extensions, file sizes, and filename patterns, mapping out the typical workflows of the client device 102B. Additionally, the security control engine 110 evaluates the programs installed or executing on the client device 102B, which can reveal the types of files and formats, including filename patterns commonly handled by the client device 102B.

Responsive to determining the file interaction characteristics associated with the client device 102B, the security control engine 110 then compares the filename pattern identified in the filename 108B to the file interaction characteristics to determine whether the client device 102B interacts with similar files during normal course of business. If the security control engine 110 determines that the filename pattern identified in the filename 108B indicates that the client device 102B commonly interacts with legitimate files containing similar filename patterns, the security control engine 110 grants the client device 102B access to the file 106B.

In contrast, however, if the security control engine 110 determines that the client device 102B does not typically interact with files containing similar filename patterns, then the security control engine 110 blocks execution of the file 106B. In such cases, the security control engine 110 may notify the client device 102B of the blocked access, such as providing a notification 114 via a user interface 112A.

In some embodiments, when the security control engine 110 blocks execution of the file 106B, the security control engine 110 also notifies an administrator or manager. For example, the client device 116 corresponds to a user tasked with overseeing the security and integrity of application platform 101 and/or the organization 104. As such, the user of the client device 116 ensures that security protocols are enforced, threats are identified and mitigated, and data integrity is preserved. In some cases, the client device 116 is directly associated with the security system 105, enabling the client device 116 to leverage comprehensive tools and resources for proactive monitoring, incident response, and the implementation of defensive strategies.

In addition to ensuring the security protocols are enforced, the client device 116 may also identify when execution policies block legitimate files. As noted above, when the security control engine 110 blocks the file 106B, the security control engine 110 generates a notification 118 and provides it via a user interface 112B to the client device 116. If responsive to receiving the notification 118, the client device 116 determines that the file 106B is legitimate and that the client device 102B is authorized to access the file 106B, the client device 116 may grant access to the file 106B. Additionally, as will be described in greater detail below, the client device 116 may notify the security control engine 110 of this misapplied block so that the security control engine 110 can update its execution policies respectively.

In some embodiments, the security control engine 110 determines, based on the file interaction characteristics associated with a client device, such as the client device 102A, that the client device 102A is likely to be tricked into opening a suspicious file. That is, based on the file interaction characteristics of client device 102A, the security control engine 110 assesses the likelihood that the client device 102A may be deceived by the suspicious filename pattern of the filename 108A. The analysis of file activity history, including which types of files are frequently opened and interacted with, can reveal patterns of vulnerability. For example, if the client device 102A consistently engages with files that contain malicious content or exhibit risky attributes, the security control engine 110 may determine that the client device 102A is susceptible to similar deceptive filename patterns. By analyzing the file interaction characteristics of the client device 102A, the security control engine 110 can identify whether certain filename patterns are effective at tricking the user of the client device 102A into accessing harmful files. Then, based on the identified filename patterns or tendency of the client device 102A to open suspicious files, the security control engine 110 may tighten the execution policy for the client device 102A, thereby blocking more files that have suspicious filename patterns for the client device 102A than other client devices within the organization 104.

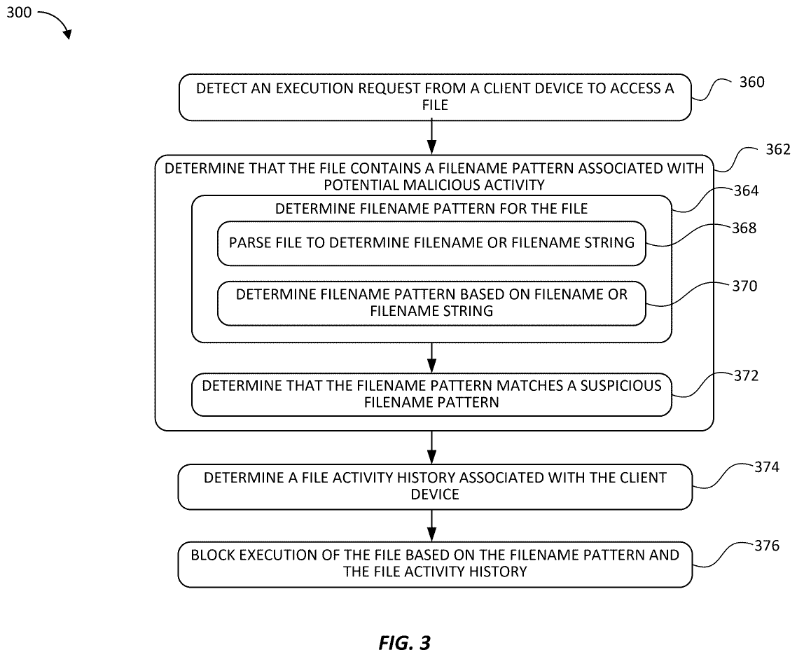

Referring now to FIG. 2, an example operational system 200 in which a security control engine 210 is provided, according to an embodiment herein. For ease of illustration, FIG. 2 is described with respect to FIG. 3, which provides a process 300 for providing a security control engine and its related functions, according to various embodiments herein. Although FIG. 3 is described in relation to FIG. 2, it should be appreciated that the process 300 of FIG. 3 is equally applicable to the remaining Figures and components therein.

The security control engine 210, which may be the same or similar to the security control engine 110, may monitor and manage secure file access of client devices 202A-B to prevent execution of malicious content. To analyze and manage the client devices' 202A-B access to suspicious files, the security control engine 210 detects requests to open or access files from the client devices 202A-B (360). That is, when the client devices 202A-B attempt to open a respective file, the security control engine 210 receives an execution request 220A-B from the client devices 202A-B respectively (360). As used herein, an execution request is a request to open or access a file, which, as described above, could include actions such as retrieving files from an email, accessing files stored within a distributed database, or interacting with files through other file-sharing or storage systems, such as via the application platform 101.

In particular, the security control engine 210 includes a detector 222 that detects when the client devices 202A-B retrieve files. For example, the detector 222 may receive the request 220A from the client device 202A when the client device 202A selects an option to open a file 206. Based on the request 220A, the file detector 222 may identify the file 206 associated with the request 220A. Once the file 206 is identified, the security control engine 210 determines whether or not the file 260 contains a filename pattern associated with potential malicious activity (362). In other words, the security control engine 210 determines whether the file 206 is a suspicious file.

To determine whether the file 206 is a suspicious file, and thus potentially contains malicious content, the security control engine 210 analyzes the file 206 to determine a filename pattern 230 of the file 206 (364). In particular, the security control engine 210 includes a filename pattern identifier 224 containing a parser 226 that parses the file 206 to determine a filename pattern 230 of the file. As those skilled in the art readily appreciate, the file 206 includes both a filename 208 and a filename string 228, each serving distinct roles in file identification and processing. As such, to determine the filename pattern 230, the parser 226 extracts the filename 208 and/or the filename string 228 from the file 206 (368). The filename 208 refers to the actual designated name of the file as recognized by the operating system or file management system, typically used for accessing or referencing the file. On the other hand, the filename string 228 is a text representation embedded within the file's 206 metadata or contents, which might describe or label the file's contents in a more descriptive or human-readable format.

Cyber-attacks often involve modifications to the filename 208 and/or the filename string 228 to disguise malicious content and trick users into executing harmful files. As such, the parser 226 extracts both the filename 208 and the filename string 228 to identify any potentially harmful filename patterns. By analyzing the filename 208, the parser 226 can detect deceptive filename patterns, such as hidden extensions or filenames that mimic legitimate software. Additionally, the parser 226 extracts the filename string 228, which may contain embedded text or descriptions that appear trustworthy but conceal malicious intentions. This thorough parsing of both the system-level filename 208 and the internal descriptive filename string 228 helps identify and flag filenames that could indicate an imminent security threat.

Once the parser 226 parses the file 206 and determines the filename 208 and/or the filename string 228, depending on the embodiment, the filename pattern identifier 224 identifies the filename pattern 230 of the file 206. Depending on the specific embodiment, the filename pattern identifier 224 analyzes the extracted filename 208 and/or the filename string 228 to detect any recurring structures, anomalies, or indicators of suspicious behavior. By examining the features of the filename 208 and/or the filename string 228, the filename pattern identifier 224 can assess whether the filename 208 and/or the filename string 228 follow conventional formats or if they exhibit traits commonly associated with malicious files.

Based on the filename pattern 230, the security control engine 210 determines whether the filename pattern 230 indicates potentially malicious activity (372). That is, the security control engine 210 includes a suspicious filename pattern identifier 232 that compares the filename pattern 230 to known suspicious filename patterns 234. It should be appreciated that while the suspicious filename pattern identifier 232 and the filename pattern identifier 224 are illustrated and discussed separately, in some embodiments, they be the same unit such to execute one or more functions in tandem. For instance, when determining the filename pattern 230 the filename pattern identifier 224 may analyze the filename 208 and the filename string 228 for suspicious filename patterns 234.

Suspicious filename patterns 234 are naming conventions or structures used by malicious actors to disguise harmful files as legitimate ones. These suspicious filename patterns 234 may include double extensions (e.g., “report.pdf.exe”), filenames that mimic trusted documents or software (e.g., “system_update.docx”), or the use of non-standard characters and hidden spaces within the filename 208 or filename string 228 to obscure the true nature of the file (e.g., “invoice.txt.exe”). Table 1 provided below illustrates example known suspicious filename pattern 234 types, where they are typically detected, and provides an example of type.

TABLE 1

| FILENAME PATTERN TYPE: | DETECTED IN: | EXAMPLE: |
|---|---|---|
| Double Extension | Filename | Document.pdf.exe |
| Non-standard characters | Filename | inv@l!d_file.txt |
| Random Character String | Filename | d4fj7s89.exe |
| Mimic System Files | Filename | svchosts.bat |
| RTLO (Right-to-Left Override) | Filename String | exetxt. |
| Uncommon File Extensions | Filename | File.docm. |
| Bidirectional Control Characters | Filename String | evilâ€ ®txt.exe |
| Mismatched File Extension | Filename | report.pdf (actually an executable file) |
| Hidden Characters | Filename String | document.txtâ€<.exe (zero-width space) |
| Obfuscated Filenames | Filename String | update.bat |
| Filename Spoofing (Padded Spaces) | Filename String | innocent_document.txt.exe |
| Hexadecimal/Encoded Characters | Filename String | doc%2Eexe |
| Unicode Homoglyphs | Filename String | updÐ°te.exe (Cyrillic ‘Ð°’) |
| Trailing Dots or Spaces | Filename String | malware.txt. |
| Filename Truncation | Filename String | image.jpg.exe |
| Combination of Benign Words | Filename String | report_readme.docx.pdf |
| Confusing or Repeated Extensions | Filename String | document.docx.exe |

To keep up with the ever-evolving digital landscape, the suspicious filename pattern identifier 232 actively analyzes and updates a database 246 of suspicious filename patterns 234. By continuously monitoring and adapting in real-time, the suspicious filename pattern identifier 232 responds to the changing strategies employed by malicious actors, ensuring that it recognizes new and emerging suspicious filename patterns 234. Through this ongoing refinement and enhancement of its detection capabilities, the suspicious filename pattern identifier 232 stays proactive in safeguarding against sophisticated attacks that leverage deceptive and constantly evolving filename tactics. While the database 246 is illustrated as separate from the security control engine 210, in some embodiments, the database 246 may be part of the security control engine 210.

In some embodiments, the suspicious filename pattern identifier 232 learns new suspicious filename patterns 234 through the integration of with an artificial intelligence (AI) model designed to detect subtle and complex patterns within filename structures. In such scenarios, the AI model continuously ingests data from various sources, including real-time threat intelligence feeds, such as from the security system 105, and historical file activity logs from monitored the client devices 202A-B, to train and adapt its understanding of emerging malicious trends. By employing machine learning algorithms, the AI model enhances the suspicious filename pattern identifier 232's ability to recognize both known and previously unseen suspicious filename patterns. The suspicious filename pattern identifier 232, powered by this AI model, refines its database 246 by incorporating newly detected patterns, enabling it to identify potential threats with greater accuracy. This adaptive learning process ensures that the suspicious filename pattern identifier 232 evolves alongside the tactics of malicious actors, maintaining robust protection against sophisticated and evolving digital threats.

If the security control engine 210 determines that the filename pattern 230 of the file 206 matches one of the suspicious filename patterns 234, the security control engine 210 determines an execution policy 238 associated with the filename pattern 230. In particular, the security control engine 210 includes an execution module 236 that determines what security policies may apply to the filename pattern 230, in particular security policies involving whether or not the client device 202A can execute and therefore access the file 206. As such, the execution module 236 determines the execution policy 238 governing the filename pattern 230. However, as described above, unlike conventional security systems, the security control engine 210 adjusts the execution policy 238 based on the contextual information behind the requests 220A to access the file 206. That is, while the execution policy 238 is a security rule or set of rules designed to block access to files that contain potentially malicious content, such as files having the filename pattern 230, preventing their execution and safeguarding the system from harm, the security control engine 210 may adjust the execution policy 238 based on the client device 202A and their file interaction characteristics such to tailor the execution policy 238 to the real-time environment.

To determine whether or not to modify the execution policy 238, the security control engine 210 may determine the file interaction characteristics associated with the client devices 202A-B. In particular, the security control engine 210 includes a file interaction characteristics module 242 that determines file activity history 244 for the client device 202A (374). As described above, the file activity history 244 of the client device 202A involves the file interactions of the client device 202A historically. In some embodiments, the file interaction characteristics module 242 determines the file activity history 244 for a predefined time period based on the date the request 220A to execute the file 206 is made. This predefined time period can be 30 days, 60 days, 90 days, or any specified range of days prior to the date when the security control engine 210 received the request 220A.

To generate the file activity history 244 for the client device 202A (and 220B), the security control engine 210 includes a file activity monitor 248. The file activity monitor 248 actively analyzes a respective client devices' 202A-B file activity history and associated programs. For example, the file activity monitor 248 tracks what legitimate files and respective types that the client devices 202A-B frequently interacts with. This may include tracking file interactions, such as file creation events, file edit events, file sharing events, image loading events, and the like. In some embodiments, the file activity monitor 248 also tracks extensions, file sizes, and filename patterns, mapping out the typical workflows of the client devices 202A-B.

In addition to the file activity history 244, the file activity monitor 248 also tracks programs installed or executing on the client devices 202A-B. By analyzing the programs that the client devices 202A-B have installed, the file activity monitor 248 can capture additional information on the types of files and formats, including filename patterns commonly handled by the client devices 202A-B. As illustrated, the file activity monitor 248 may store the file activity history 244 and other file interaction characteristics, such as respective program usage, in the database 246. As such, when the security control engine 210 assesses the request 220A, the file interaction characteristics module 242 can access the most up-to-date and real-time file interaction characteristics about the client device 202A.

In some embodiments, the file interaction characteristics module 242 determines the file activity history specific to each client device, such as the file activity history 244 for client device 202A. In other embodiments, the module 242 determines the file activity history 244 for a group, such as a department, job role, job title, or for the entire organization. As can be appreciated, analyzing contextual information such as the file activity history 244 for other client devices within the same department or associated with a similar job title as the client device 202A, the security control engine 210 can determine whether interaction with files having similar filename patterns as the file 106 is within the normal course of business.

Once the security control engine 210 determines the file activity history 244, as well as other file interaction characteristics, depending on the embodiment, the security control engine 210 then analyzes the filename pattern 230 identified for the file 206 against the file activity history 244 for the client device 202A. Specifically, the execution module 236 analyzes the file activity history 244 to determine whether or not the execution policy 238 for the client device 202A should be modified to allow execution of the file 206. If based on the file activity history 244, the execution module 236 determines that the client device 202A typically interacts with files having the same or similar filename patterns, then the execution module 236 modifies the execution policy 238 to allow the client device 202A to access the file 206.

In contrast, if the execution module 236 determines that the client device 202A typically does not interact with files containing the same or similar filename patterns to the filename pattern 230, then the execution module 236 may block execution of the file (376). In particular, the execution module 236 includes an execution blocker 240 that blocks execution of the file 206 responsive to the request 220A. The execution blocker 240 prevents access to the file 206 by denying the request 220A, effectively blocking access and preventing the client device 202A from opening the file 206.

Since the security control engine 210 adjusts the execution policy 238 based on the contextual information, primarily based on the client device requesting access to the file 206, there are embodiments where the security control engine 210 blocks access to the file 206 for the client device 202A while allowing the client device 202B to execute the file 206. For example, the security control engine 210 may determine that the client device 202A routinely opens files containing malicious content, and as such may apply the execution policy 238 to block access to the file 206 because it contains the filename pattern 230. The execution module 236 may even block access to the file 206 for the client device 202A if the file activity history 244 indicates that the client device 202A has interacted with a few legitimate files containing the same or similar filename patterns. As can be appreciated, by adjusting the execution policy 238 to accommodate the client device's 202A propensity to be tricked by suspicious filename patterns, the security control engine 210 can prevent malicious activity.

In contrast to the above example, the security control engine 210 may grant access to the file 206 for the client device 202B based on its respective file activity history 244, despite the filename pattern 230 indicating malicious activity. For instance, if the file activity history 244 for the client device 202B indicates that the client device 202B typically interacts with files containing the same or similar filename patterns, then the execution module 236 may grant the request 220B. In another case, the file activity history 244 may indicate that the client device 202B is unlikely to be tricked by suspicious files, such as repeatedly reporting suspicious files to the security system 105, then the execution module 236 may grant the request 220B to access the file 206. By modifying the execution policy 238 based on the file activity history 244, the security control engine 210 can tailor its security features to the specific client devices and users operating them in real-time.

Once the execution module 236 makes a determination to grant or block access to the file 206, the security control engine 210 notifies the file activity monitor 248 of the requests 220A-B and its decision. Responsively, the file activity monitor 248 updates the database 246 to incorporate the requests 220A-B and subsequent actions of accessing the file 206 or being blocked into the file activity history 244 for the respective client devices 202A-B.

In addition to updating the file activity history 244, the security control engine 210 also notifies any respective security personnel of the decision. In particular, the security control engine 210 includes a notification generator 250 that generates a notification 218 and transmits it to a client device 216. In the illustrated example, the client device 216, which may be the same or similar to the client device 116, is associated with a user who manages the security of the client devices 202A-B, such as an administrator within the security system 105. By notifying the client device 216, if the security control engine 210 blocks a legitimate file, then the user of the client device 216 can assess and inform the security control engine 210 of the incorrect application of the execution policy 238. As shown, the client device 216 submits input 252 to the security control engine 210 indicating that the file 206 is legitimate, despite the security control engine 210 identifying it as potentially containing malicious content.

Responsive to receiving the input 252, the security control engine 210 updates the execution policy 238, specifically with respect to the device for which the block was implemented, such as the client device 202A. Conversely, if the client device 216 indicates, via the input 252 that the file 206 contains malicious content despite the security control engine 210 determining it as a legitimate file, the security control engine 210 updates the execution policy 238 to reflect the input 252.

In some embodiments, the notification generator 250 also generates a notification 214 and provides it to a respective client device 202A responsive to instituting a block of the file 206. As can be appreciated, notifying the client device 202A allows a respective user to notify the security system, such as the client device 216 if the file 206 is in fact a legitimate file. Again, in such cases, the client device 216 then submits the input 252 to the security control engine 210 indicating that the file 206 is legitimate and the security control engine 210 can update the execution policy 238 to address the incorrect block. Once a blocked file is identified as legitimate, the security control engine 210 may grant access to the file 206 or the security system may release the file 206 for access by the requesting client device 202A-B.

Referring to FIG. 4, FIG. 4 illustrates a computing apparatus 491 that may be used for providing a security control engine and related functions, as described herein. For example, the client devices 102A-B, 202A-B, 116, or 216 may be or include the computing apparatus 491. As illustrated, the computing apparatus 491 includes a processing system 492 that includes a microprocessor and other circuitry that retrieves and executes software 495 from storage system 493. The processing system 492 may be implemented within a single processing device but may also be distributed across multiple processing devices or sub-systems that cooperate in executing program instructions. Examples of the processing system 492 include general purpose central processing units, graphical processing units, application specific processors, and logic devices, as well as any other type of processing device, combinations, or variations thereof.

The storage system 493 may comprise any computer-readable storage media or medium readable by processing system 492 and capable of storing software 495. The storage system 493 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 493 may also include computer readable communication media over which at least some of the software 495 may be communicated internally or externally. The storage system 493 may be implemented as a single storage device but may also be implemented across multiple storage devices or sub-systems co-located or distributed relative to each other. The storage system 493 may comprise additional elements, such as a controller capable of communicating with the processing system 492 or possibly other systems.

The software 495 (including security control engine process 496) may be implemented in program instructions and among other functions may, when executed by the processing system 492, direct the processing system 492 to operate as described with respect to the various operational scenarios, sequences, and processes illustrated herein. For example, the software 495 may include program instructions for implementing a security control engine and related functions, such as the process 300, as described herein. In some cases, the software 495 may cause one or more features of the security control engine process 496 to provide or display respective components to a user via a user interface system 499 inoperable communication with a client device, such as the user interface 112A of the client device 102B or the user interface 112B of the client device 116.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 495 may include additional processes, programs, or components, such as operating system software, virtualization software, or other application software. The software 495 may also comprise firmware or some other form of machine-readable processing instructions executable by the processing system 492.

In general, the software 495 may, when loaded into the processing system 492 and executed, transform a suitable apparatus, system, or device (of which computing apparatus 491 is representative) overall from a general-purpose computing system into a special-purpose computing system customized to generate features, functionality, and user experiences provided by the security control engine. Indeed, encoding the software 495 on the storage system 493 may transform the physical structure of the storage system 493. The specific transformation of the physical structure may depend on various factors in different implementations of this description. Examples of such factors may include, but are not limited to, the technology used to implement the storage media of the storage system 493 and whether the computer-storage media are characterized as primary or secondary storage, as well as other factors.

For example, if the computer readable storage media are implemented as semiconductor-based memory, the software 495 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 497 may include communication connections and devices that allow for communication with other computing systems (not shown) over communication networks (not shown). Examples of connections and devices that together allow for inter-system communication may include network interface cards, antennas, power amplifiers, Radio Frequency (RF) circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing apparatus 491 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of which may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a security control engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage media; a security control engine comprising processor-executable instructions stored on the computer-readable storage media; and a processor coupled to the computer-readable storage media and configured to execute the processor-executable instructions, wherein the processor-executable instructions, when executed by the processor, direct the computing apparatus, to at least: detect a request to execute a first file from a client device; parse the first file to determine a first filename pattern; determine that the first filename pattern indicates potential malicious activity; determine file activity history associated with the client device; and prevent execution of the first file based on the first filename pattern of the first file and the file activity history associated with the client device.

Example 2 is the computing apparatus of any previous or subsequent Example, wherein the processor-executable instructions to determine the file activity history associated with the client device, when executed by the processor, further direct the computing apparatus to: determine a plurality of file interactions performed by the client device within a first time period; determine a plurality of filename patterns associated with the plurality of file interactions; and determine that the plurality of filename patterns lacks the first filename pattern.

Example 3 is the computing apparatus of any previous or subsequent Example, wherein the processor-executable instructions when executed by the processor, further direct the computing apparatus to: receive an indication that the first file is legitimate; determine an execution policy associated with the client device; modify the execution policy for files comprising the first filename pattern; and grant the request to execute the first file for the client device.

Example 4 is the computing apparatus of any previous or subsequent Example, wherein the processor-executable instructions to, when executed by the processor, further direct the computing apparatus to: receive a second request to execute a second file from the client device; determine a second filename pattern of the second file; determine that the second filename pattern indicates potential malicious activity; and allow execution of the second file based on the file activity history of the client device and the second filename pattern.

Example 5 is the computing apparatus of any previous or subsequent Example, wherein the processor-executable instructions to prevent execution of the first file based on the first filename pattern of the first file and the file activity history associated with the client device, when executed by the processor, further direct the computing apparatus to: analyze the file activity history associated with the client device to determine whether the client device historically interacts with files comprising the first filename pattern; and block execution of the first file based on the client device historically interacting files lacking the first filename pattern.

Example 6 is the computing apparatus of any previous or subsequent Example, wherein: the processor-executable instructions to parse the first file to determine a first filename pattern, when executed by the processor, further direct the computing apparatus to: determine at least one of a first filename or a first filename string of the first file; and determine the first filename pattern based on the at least one of the first filename or the first filename string; and the processor-executable instructions to determine that the first filename pattern indicates potential malicious activity, when executed by the processor, further direct the computing apparatus to: detect one or more of the following within the at least one of the first filename or the first filename string: a mismatch between a file extension in the first filename indicated in the first filename string and a file type of the first file; hidden characters; bidirectional (Bidi) control characters; non-standard characters; double extensions; or random character string.

Example 7 is a method comprising: detecting, by a security control engine, an execution request to open a first file from a first client device; parsing, by the security control engine, the first file to determine a first filename and a first filename string; determining, by the security control engine, a first filename pattern for the first file based on at least one of the first filename or the first filename string; determining, by the security control engine, that the first filename pattern comprises a suspicious filename pattern; determining, by the security control engine, a first file activity history associated with the first client device; determining, by the security control engine, a first execution policy for the first client device based on the first file activity history and the first filename pattern; and blocking, by the security control engine, the first client device from executing the first file based on the first filename pattern and the first file activity history.

Example 8 is the method of any previous or subsequent Example, wherein determining, by the security control engine, the file activity history associated with the client first devices comprises: determining, by the security control engine, a plurality of client devices associated with the first client device; determining, by the security control engine, a file activity history associated with the plurality of client devices; and determining, by the security control engine, the first file activity history based on the file activity history associated with the plurality of client devices.

Example 9 is the method of any previous or subsequent Example, wherein the method further comprises: determining, by the security control engine, that the first file is legitimate; and modifying, by the security control engine, the first execution policy for the first client device responsive to determining that the first file is legitimate, wherein modifying the first execution policy comprises allowing the first client device to execute files comprising the first filename pattern.

Example 10 is the method of any previous or subsequent Example, wherein: determining, by the security control engine, the first file activity history associated with the first client device comprises: determining, by the security control engine, a plurality of file interactions during which the first client device executed files comprising malicious content; and determining, by the security control engine, the first execution policy for the first client device based on the first file activity history and the first filename pattern comprises: determining, by the security control engine, the first execution policy for the first client device based on the plurality of file interactions involving execution of files comprising malicious content, wherein the first execution policy prevents the first client device from executing files comprising the first filename pattern.

Example 11 is the method of any previous or subsequent Example, wherein the method further comprises: generating, by the security control engine, a notification indicating that the first file is blocked for the first client device; and transmitting, by the security control engine, the notification to a second client device.

Example 12 is the method of any previous or subsequent Example, wherein the method further comprises: updating, by the security control engine, the first file activity history to indicate that the first client device submitted the execution request to open the first file comprising the first filename pattern.

Example 13 is the method of any previous or subsequent Example, wherein the method further comprises: detecting, by the security control engine, a second execution request to open the first file from a second client device; determining, by the security control engine, a second file activity history associated with the second client device; and granting, by the security control engine, the second execution request to open the first file based on the second file activity history and the first filename pattern.

Example 14 is the method of any previous or subsequent Example, wherein determining, by the security control engine, that the first filename pattern comprises the suspicious filename pattern comprises: determining, by the security control engine, a file type of the first file; determining, by the security control engine, an extension indicated in the first filename string of the first file; and determining, by the security control engine, a mismatch between the file type and the extension indicated in the first filename string.

Example 15 is a computer readable storage media comprising processor-executable instructions configured to cause a processor to: identify, by a security control engine, a first file comprising a first filename and a first filename string; determine, by the security control engine, a first filename pattern present in the first filename or the first filename string determine, by the security control engine, an execution policy associated with the first filename pattern; determine, by the security control engine, a file activity history for at least one client device; and block, by the security control engine, execution of the first file based on the execution policy and the file activity history for the at least one client device.

Example 16 is the computer readable storage media of any previous or subsequent Example, wherein: the processor-executable instructions to determine, by the security control engine, the file activity history for at least one client device cause the processor to further execute processor-executable instructions stored in the computer readable storage media to: determine, by the security control engine, a plurality of file executions performed by the at least one client device within a first time period; and determine, by the security control engine, that the plurality of file executions performed within the first time period lacks files comprising the first filename pattern; and the processor-executable instructions to block, by the security control engine, execution of the first file based on the execution policy and the file activity history for the at least one client device cause the processor to further execute processor-executable instructions stored in the computer readable storage media to: block, by the security control engine, execution of the first file based on the plurality of file executions performed within the first time period lacking files comprising the first filename pattern.

Example 17 is the computer readable storage media of any previous or subsequent Example, wherein the processor-executable instructions cause the processor to further execute processor-executable instructions stored in the computer readable storage media to: receive, by the security control engine, an indication that the first file is legitimate; and modify, by the security control engine, the execution policy for files comprising the first filename pattern for the at least one client device.

Example 18 is the computer readable storage media of any previous or subsequent Example, wherein the processor-executable instructions cause the processor to further execute processor-executable instructions stored in the computer readable storage media to: detect, by the security control engine, a request to execute a second file from the at least one client device; determine, by the security control engine, a second filename or second filename string of the second file; determine, by the security control engine, a second execution policy associated with a second filename pattern present in the second filename or the second filename string; and grant, by the security control engine, the request to execute the second file based on the second execution policy and the file activity history for the at least one client device.

Example 19 is the computer readable storage media of any previous or subsequent Example, wherein the processor-executable instructions to determine, by the security control engine, the first filename pattern present in the first filename or the first filename string cause the processor to further execute processor-executable instructions stored in the computer readable storage media to: detect one or more of the following within the first filename or the first filename string: a mismatch between a file extension in the first filename indicated in the first filename string and a file type of the first file; hidden characters; bidirectional (Bidi) control characters; non-standard characters; double extensions; or random character string.

Example 20 is the computer readable storage media of any previous or subsequent Example, wherein: the at least one client device comprises a first client device and a second client device; and the processor-executable instructions to determine, by the security control engine, the file activity history for at least one client device cause the processor to further execute processor-executable instructions stored in the computer readable storage media to: determine, by the security control engine, a first file activity history for a first client device, wherein the first file activity history comprises a plurality of file interactions performed by the first client device for a first plurality of files; determine, by the security control engine, a second file activity history for a second client device, wherein the second file activity history comprises a plurality of file interactions performed by the second client device for a second plurality of files; determine, by the security control engine, a plurality of filename patterns associated with the first plurality of files and the second plurality of files; and determine, by the security control engine, the file activity history for the at least one client device based on the plurality of filename patterns.

What is claimed is:

1. A computing apparatus comprising:
a computer-readable storage media;
a security control engine comprising processor-executable instructions stored on the computer-readable storage media; and
a processor coupled to the computer-readable storage media and configured to execute the processor-executable instructions, wherein the processor-executable instructions, when executed by the processor, direct the computing apparatus, to at least:
detect a request to execute a first file from a client device;
parse the first file to determine a first filename pattern;
determine that the first filename pattern indicates potential malicious activity;
determine file activity history associated with the client device; and
prevent execution of the first file based on the first filename pattern of the first file and the file activity history associated with the client device.

2. The computing apparatus of claim 1, wherein the processor-executable instructions to determine the file activity history associated with the client device, when executed by the processor, further direct the computing apparatus to:
determine a plurality of file interactions performed by the client device within a first time period;
determine a plurality of filename patterns associated with the plurality of file interactions; and
determine that the plurality of filename patterns lacks the first filename pattern.

3. The computing apparatus of claim 1, wherein the processor-executable instructions when executed by the processor, further direct the computing apparatus to:
receive an indication that the first file is legitimate;
determine an execution policy associated with the client device;
modify the execution policy for files comprising the first filename pattern; and
grant the request to execute the first file for the client device.

4. The computing apparatus of claim 1, wherein the processor-executable instructions to, when executed by the processor, further direct the computing apparatus to:
receive a second request to execute a second file from the client device;
determine a second filename pattern of the second file;
determine that the second filename pattern indicates potential malicious activity; and
allow execution of the second file based on the file activity history of the client device and the second filename pattern.

5. The computing apparatus of claim 1, wherein the processor-executable instructions to prevent execution of the first file based on the first filename pattern of the first file and the file activity history associated with the client device, when executed by the processor, further direct the computing apparatus to:
analyze the file activity history associated with the client device to determine whether the client device historically interacts with files comprising the first filename pattern; and
block execution of the first file based on the client device historically interacting files lacking the first filename pattern.

6. The computing apparatus of claim 1, wherein:
the processor-executable instructions to parse the first file to determine a first filename pattern, when executed by the processor, further direct the computing apparatus to:
determine at least one of a first filename or a first filename string of the first file; and
determine the first filename pattern based on the at least one of the first filename or the first filename string; and
the processor-executable instructions to determine that the first filename pattern indicates potential malicious activity, when executed by the processor, further direct the computing apparatus to:
detect one or more of the following within the at least one of the first filename or the first filename string:
a mismatch between a file extension in the first filename indicated in the first filename string and a file type of the first file;
hidden characters;
bidirectional (Bidi) control characters;
Right-To-Left Override (RTLO);
non-standard characters;
double extensions; or
random character string.

7. A method comprising:
detecting, by a security control engine, an execution request to open a first file from a first client device;
parsing, by the security control engine, the first file to determine a first filename and a first filename string;
determining, by the security control engine, a first filename pattern for the first file based on at least one of the first filename or the first filename string;
determining, by the security control engine, that the first filename pattern comprises a suspicious filename pattern;
determining, by the security control engine, a first file activity history associated with the first client device;
determining, by the security control engine, a first execution policy for the first client device based on the first file activity history and the first filename pattern; and
blocking, by the security control engine, the first client device from executing the first file based on the first filename pattern and the first file activity history.

8. The method of claim 7, wherein determining, by the security control engine, the file activity history associated with the client first devices comprises:
determining, by the security control engine, a plurality of client devices associated with the first client device;
determining, by the security control engine, a file activity history associated with the plurality of client devices; and
determining, by the security control engine, the first file activity history based on the file activity history associated with the plurality of client devices.

9. The method of claim 7, wherein the method further comprises:
determining, by the security control engine, that the first file is legitimate; and
modifying, by the security control engine, the first execution policy for the first client device responsive to determining that the first file is legitimate, wherein modifying the first execution policy comprises allowing the first client device to execute files comprising the first filename pattern.

10. The method of claim 7, wherein:
determining, by the security control engine, the first file activity history associated with the first client device comprises:
determining, by the security control engine, a plurality of file interactions during which the first client device executed files comprising malicious content; and
determining, by the security control engine, the first execution policy for the first client device based on the first file activity history and the first filename pattern comprises:
determining, by the security control engine, the first execution policy for the first client device based on the plurality of file interactions involving execution of files comprising malicious content, wherein the first execution policy prevents the first client device from executing files comprising the first filename pattern.

11. The method of claim 7, wherein the method further comprises:
generating, by the security control engine, a notification indicating that the first file is blocked for the first client device; and
transmitting, by the security control engine, the notification to a second client device.

12. The method of claim 7, wherein the method further comprises:
updating, by the security control engine, the first file activity history to indicate that the first client device submitted the execution request to open the first file comprising the first filename pattern.

13. The method of claim 7, wherein the method further comprises:
detecting, by the security control engine, a second execution request to open the first file from a second client device;
determining, by the security control engine, a second file activity history associated with the second client device; and
granting, by the security control engine, the second execution request to open the first file based on the second file activity history and the first filename pattern.

14. The method of claim 7, wherein determining, by the security control engine, that the first filename pattern comprises the suspicious filename pattern comprises:
determining, by the security control engine, a file type of the first file;
determining, by the security control engine, an extension indicated in the first filename string of the first file; and
determining, by the security control engine, a mismatch between the file type and the extension indicated in the first filename string.

15. A computer readable storage media comprising processor-executable instructions configured to cause a processor to:
identify, by a security control engine, a first file comprising a first filename and a first filename string;
determine, by the security control engine, a first filename pattern present in the first filename or the first filename string
determine, by the security control engine, an execution policy associated with the first filename pattern;
determine, by the security control engine, a file activity history for at least one client device; and
block, by the security control engine, execution of the first file based on the execution policy and the file activity history for the at least one client device.

16. The computer readable storage media of claim 15, wherein:
the processor-executable instructions to determine, by the security control engine, the file activity history for at least one client device cause the processor to further execute processor-executable instructions stored in the computer readable storage media to:
determine, by the security control engine, a plurality of file executions performed by the at least one client device within a first time period; and
determine, by the security control engine, that the plurality of file executions performed within the first time period lacks files comprising the first filename pattern; and
the processor-executable instructions to block, by the security control engine, execution of the first file based on the execution policy and the file activity history for the at least one client device cause the processor to further execute processor-executable instructions stored in the computer readable storage media to:
block, by the security control engine, execution of the first file based on the plurality of file executions performed within the first time period lacking files comprising the first filename pattern.

17. The computer readable storage media of claim 15, wherein the processor-executable instructions cause the processor to further execute processor-executable instructions stored in the computer readable storage media to:
receive, by the security control engine, an indication that the first file is legitimate; and
modify, by the security control engine, the execution policy for files comprising the first filename pattern for the at least one client device.

18. The computer readable storage media of claim 15, wherein the processor-executable instructions cause the processor to further execute processor-executable instructions stored in the computer readable storage media to:
detect, by the security control engine, a request to execute a second file from the at least one client device;
determine, by the security control engine, a second filename or second filename string of the second file;
determine, by the security control engine, a second execution policy associated with a second filename pattern present in the second filename or the second filename string; and
grant, by the security control engine, the request to execute the second file based on the second execution policy and the file activity history for the at least one client device.

19. The computer readable storage media of claim 15, wherein the processor-executable instructions to determine, by the security control engine, the first filename pattern present in the first filename or the first filename string cause the processor to further execute processor-executable instructions stored in the computer readable storage media to:
detect one or more of the following within the first filename or the first filename string:
a mismatch between a file extension in the first filename indicated in the first filename string and a file type of the first file;
hidden characters;
bidirectional (Bidi) control characters;
Right-To-Left Override (RTLO);
non-standard characters;
double extensions; or
random character string.

20. The computer readable storage media of claim 15, wherein:
the at least one client device comprises a first client device and a second client device; and
the processor-executable instructions to determine, by the security control engine, the file activity history for at least one client device cause the processor to further execute processor-executable instructions stored in the computer readable storage media to:
determine, by the security control engine, a first file activity history for a first client device, wherein the first file activity history comprises a plurality of file interactions performed by the first client device for a first plurality of files;
determine, by the security control engine, a second file activity history for a second client device, wherein the second file activity history comprises a plurality of file interactions performed by the second client device for a second plurality of files;
determine, by the security control engine, a plurality of filename patterns associated with the first plurality of files and the second plurality of files; and
determine, by the security control engine, the file activity history for the at least one client device based on the plurality of filename patterns.
